(19) United States
(12) Patent Application Publication
(10) Pub. No.: US 2003/0014450 A1
(43) Pub. Date: Jan. 16, 2003

(54) Auto-correcting URL-parser

(75) Inventor: Richard Dale Hoffman, Austin, TX (US)

Correspondence Address: Cynthia S. Byrd, International Business Machines, Intellectual Property Law, 11400 Burnet Rd., Austin, TX, 78758, US

(73) Assignee: INTERNATIONAL BUSINESS MACHINES CORPORATION, ARMONK, NY (US)

(21) Appl. No.: 09/895,094

(22) Filed: Jun. 29, 2001

(51) Int. Cl. G06F 15/00

(52) U.S. Cl. 707/533; 707/513

(57) ABSTRACT

A method, system and product for correcting a character string entered at an IP client is disclosed. Upon receipt of the character string at the client, the character string is checked for typing errors. Detected typing errors are automatically corrected, absent input from a user to produce a corrected character string.

### TECHNICAL FIELD

The present invention relates generally to transactions over computer networks and more particularly to a method for enabling communications between a client and server in the event that a network path has been typed or otherwise entered incorrectly by a user.

### DESCRIPTION OF THE RELATED ART

The World Wide Web is the Internet's multimedia information retrieval system. In the Web environment, client machines effect transactions to Web servers using the Hypertext Transfer Protocol (HTTP), which is a known application protocol providing users access to files (e.g., text, graphics, images, sound, video, etc.) using a standard page description language known as Hypertext Markup Language (HTML). HTML provides basic document formatting and allows the developer to specify “links” to other servers and files. In the Internet paradigm, a network path to a server is identified by a so-called Uniform Resource Locator (URL) having a special syntax for defining a network connection. Use of an HTML-compatible browser (e.g., Netscape Navigator or Microsoft Internet Explorer) at a client machine involves specification of a link via the URL. In response, the client makes a request to the server (sometimes referred to as a “Web site”) identified in the link and, in return, receives in return a document or other object formatted according to HTML.

Typically, a user specifies a given URL manually by typing the desired character string in an address field of the browser. Existing browsers provide some assistance in this regard. In particular, both Netscape Navigator (Version 3.0 and higher) and Microsoft Internet Explorer (Version 3.0 and higher) store URLs that have been previously accessed from the browser during a given time period. Thus, when the user begins entering a URL, the browser performs a “type-ahead” function while the various characters comprising the string are being entered. Thus, for example, if the given URL is “http://www.ibm.com” (and that URL is present in the URL list), the browser parses the initial keystrokes against the stored URL list and provides a visual indication to the user of a “candidate” URL that the browser considers to be a “match”. Thus, as the user is entering the URL he or she desires to access, the browser may “look ahead” and pull a candidate URL from the stored list that matches. If the candidate URL is a match, the user need not complete entry of the fully-resolved URL; rather, he or she simply actuates the “enter” key and the browser is launched to the site.

URL resolution through this “look ahead” approach has provided some benefits, but the technique is unsatisfactory because the target URL may not be on the saved list. Alternatively, a portion of the target URL (e.g., the second level domain name) may be saved in the list but the typing error may be a particular directory or file name toward the end of the long string of characters. In either case, the user is forced to enter a long character string, only to find that the string cannot be meaningfully resolved (by a network naming service or a particular Web server, as the case may be). If the URL includes an error, a “server not found” error message or the like is returned to the user.

It is easy to mistype a URL by substituting commas for periods or misspelling the domain name. A system that automatically substitutes periods for commas whenever found in a URL, and fixes common mistakes in the spelling of the top level domain name would be very useful.

### SUMMARY OF THE INVENTION

The present invention provides a method, system and computer program product for correcting a character string entered at an IP client. Upon receipt at the client of the character string, the character is checked string for typing errors. If a typing error is detected, the error is corrected absent input from a user to produce a corrected character string. Preferably, the typing errors are predefined and can be customized to correct errors unique to a certain user.

A method of editing a character string entered at an IP client connectable to a plurality of IP servers in a computer network, each of the IP servers having an IP address is also provided. In response to entry of the character string at the IP client, errors in the character string are corrected. The errors are selected from punctuation errors and spelling errors. The IP client is connected to an IP server identified by the corrected IP server address.

The present invention is not limited to resolving incorrect URLs directed to HTTP-compliant Web servers. Generalizing, the principles of the present invention are also useful in resolving incorrect Uniform Resource Identifier (URIs) specifying FTP, SMTP or other Internet Protocol (IP)-based servers.

The foregoing has outlined some of the more pertinent objects and features of the present invention. These objects should be construed to be merely illustrative of some of the more prominent features and applications of the invention. Many other beneficial results can be attained by applying the disclosed invention in a different manner or modifying the invention as will be described. Accordingly, other objects and a fuller understanding of the invention may be had by referring to the following Detailed Description of the Preferred Embodiment.

### BRIEF DESCRIPTION OF THE DRAWINGS

For a more complete understanding of the present invention and the advantages thereof, reference should be made to the following Detailed Description taken in connection with the accompanying drawings in which:

FIG. 1 is a representative Web client/Web server used in the present invention; and

FIG. 2 is a flow diagram of a preferred implementation of the correction process of the present invention.

### DETAILED DESCRIPTION OF THE PREFERRED EMBODIMENT

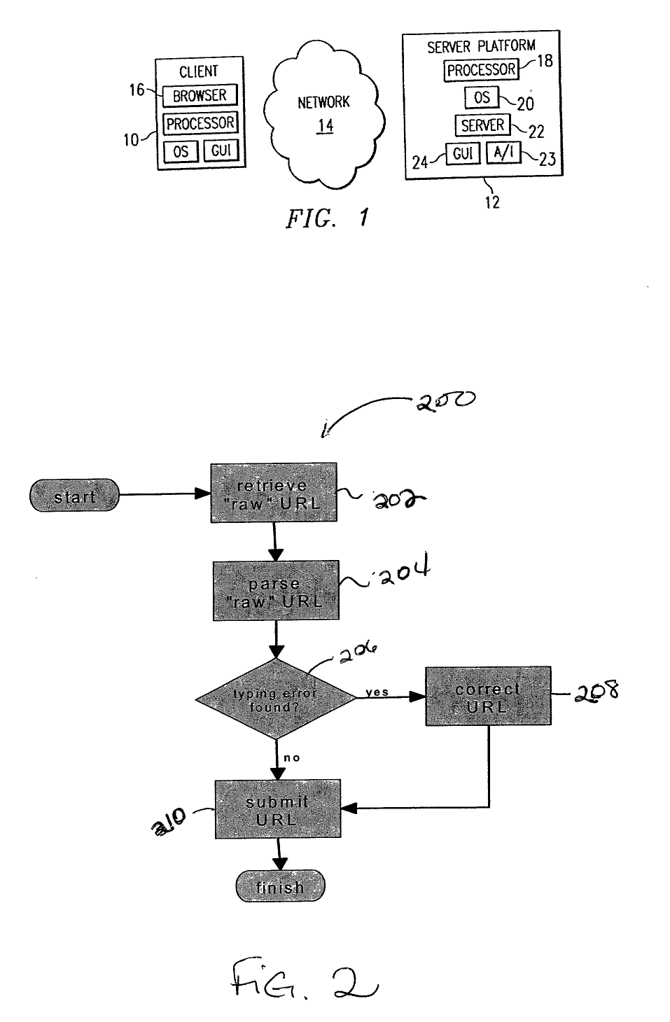

The present invention is preferably implemented in a client-server computer network. A representative Web client/Web server is illustrated in FIG. 1. In particular, a client machine 10 is connected to a Web server platform 12 via a communication channel 14. For illustrative purposes, channel 14 is the Internet, an intranet, an extranet or any other known network connection. Web server platform 12 is one of a plurality of servers which are accessible by clients, one of which is illustrated by machine 10. A representative client machine includes a browser 16, which is a known software tool used to access the servers of the network. The Web server platform (sometimes referred to as a “Web” site) supports files in the form of hypertext documents and objects. The network path to a server is identified by a Uniform Resource Locator (URL), as is well-known. A URL is a specific form of Uniform Resource Identifier (URI), as implemented in the HTTP 1.1 Specification, Internet Engineering Task Force (IETF) RFC xxxx, which is incorporated herein by reference.

A representative Web Server platform 12 comprises an IBM RISC System/6000 computer 18 (a reduced instruction set of so-called RISC-based workstation) running the AIX (Advanced Interactive Executive Version 4.1 and above) Operating System 20 and a Web server program 22, such as Netscape Enterprise Server Version 2.0, that supports interface extensions. The platform 12 also includes a graphical user interface (GUI) 24 for management and administration. The Web server 18 also includes an Application Programming Interface (API) 23 that provides extensions to enable application developers to extend and/or customize the core functionality thereof through software programs commonly referred to as “plug-ins” or helper applications.

A representative Web client is a personal computer that is x86-, PowerPC®- or RISC-based, that includes an operating system such as IBM OS/2® or Microsoft Windows 95®, and that includes a browser, such as Netscape Navigator 3.0 (or higher), having a Java Virtual Machine (JVM) and support for application plug-ins and helper applications.

A Uniform Resource Locator (URL) has the following common syntax:

http://www.name.com/directory/file

where “name” is a so-called “second level” domain name and the “.com” is a so-called “top level” domain name. In the above example, the “.com” is merely illustrative as other known or future top level domain names (e.g., .org, .edu, .biz, museum, etc.) are or may be used. When a user enters a URL in a browser address field, some portion of the URL may be incorrect. The present invention implements a simple detection scheme for correcting the input error. The scheme calls for detecting predefined typing errors. The typing errors can include punctuation errors and spelling errors in the extension. The application scans the URL for predefined errors and corrects the errors upon detection. For illustrative purposes, the following typing errors would be detected and corrected before any transmission, saving time and bandwidth:

| error | correction |
|---|---|
| htp or htps | http |
| single slash after | double slash |
| : | |
| no colon before | add colon |
| slash | |
| comma | period |
| .con | .com |

In addition, the list of corrections can be configured to add errors that a user typically makes, such as replacing “co” with “com”.

FIG. 2 is a flow diagram of a preferred implementation of the correction process of the present invention. The routine begins at step 200 when a user enters a character string or URL, preferably in the address field of the Web client browser. At step 202, the “raw” or unedited URL typed in by the user is retrieved. The routine then parses the raw URL, step 204. The character string is checked for typing errors at step 206. If a typing error is found, the routine corrects the error, step 208. Errors are corrected by replacing each typing error with the correct punctuation or spelling. Once the errors are corrected, the URL is submitted at step 210. The client is then connected to the server identified by the corrected URL or character string.

The present invention provides numerous advantages. Existing Web client-based “look ahead” approaches cannot recognize URLs that contain simple typing errors. Because to err is human, the use of such “local” lists to resolve misspelled URLs does not provide suitable results. Using the present invention, a user can type in an incorrect character string and the browser will automatically correct a pre-defined set of typing errors without any further user input. The method and system thus resolve an incorrect character string into an electronic address known to the computer. Preferably, the software program can be configured to catch the most common user typing errors.

The above-described functionality is preferably implemented at the client. Generalizing, the software is simply a computer program product implemented in a computer-readable medium or otherwise downloaded to the client over the computer network. The functionality may be built into the browser, or is implemented as a browser plug-in or helper application. Alternatively, the functionality may be implemented as a Java applet or application.

The correction scheme, of course, may be generalized for any Uniform Resource Identifier (“URI”), of which the URL is a special case. Thus, the present invention may be used in other Internet services including, without limitation, file transfer (using the file transfer protocol (FTP)), point-to-point messaging or e-mail (using the simple message transport protocol (SMTP), and the like.

In the preferred embodiment, “entry” of a URL is typically accomplished using a keyboard associated with the client machine. This is not a limitation of the present invention, however. The particular manner by which the incorrect URL is entered is not a limitation of the invention. Thus, for example, a URL may be entered by other than keyboard entry (e.g., voice commands or by a suitable speech recognizer).

One of the preferred implementations of invention is thus as a set of instructions (program code) in a code module resident in the random access memory of the computer. Until required by the computer, the set of instructions may be stored in another computer memory, for example, in a hard disk drive, or in a removable memory such as an optical disk (for eventual use in a CD ROM) or floppy disk (for eventual use in a floppy disk drive), or downloaded via the Internet or other computer network.

In addition, although the various methods described are conveniently implemented in a general purpose computer selectively activated or reconfigured by software, one of ordinary skill in the art would also recognize that such methods may be carried out in hardware, in firmware, or in more specialized apparatus constructed to perform the required method steps.

Further, as used herein, “Web client” should be broadly construed to mean any computer or component thereof directly or indirectly connected or connectable in any known or later-developed manner to a computer network, such as the Internet. The term “Web server” should also be broadly construed to mean a computer, computer platform, an adjunct to a computer or platform, or any component thereof. Of course, a “client” should be broadly construed to mean one who requests or gets the file, and “server” is the entity which downloads the file. As previously discussed, the features of the invention may be implemented in any IP client, and not just a HTTP-compliant Web client running a Web browser.

1. A method of correcting a character string entered at an IP client comprising:
upon receipt of the character string at the client, checking the character string for typing errors; and
upon detection of a typing error, correcting the typing error, absent input from a user to produce a corrected character string.

2. The method of claim 1 wherein the typing errors are selected from punctuation errors and spelling errors.

3. The method of claim 1 further comprising:
when the typing error is a punctuation error, replacing the punctuation error with a correct punctuation mark.

4. The method of claim 2 further comprising:
when the typing error is a spelling error, replacing the spelling error with a correct spelling.

5. The method of claim 1 wherein the typing errors are predefined.

6. The method of claim 2 wherein the spelling errors are predefined.

7. The method of claim 2 wherein the punctuation errors are predefined.

8. The method of claim 1 further comprising connecting the IP client to an IP server identified by the corrected character string.

9. A method of editing a character string entered at an IP client connectable to a plurality of IP servers in a computer network, each of the IP servers having an IP address, comprising:
responsive to entry of the character string at the IP client, correcting errors in the character string selected from punctuation errors and spelling errors; and
connecting the IP client to an IP server identified by the corrected IP server address.

10. A data processing system comprising:
a bus system;
a communications unit connected to the bus system;
a memory connected to the bus system, wherein the memory includes a set of instructions; and
a processing unit connected to the bus system, wherein the processing unit executes the set of instructions toin response to receiving a character string at a client, checking the character string for typing errors; and
upon detection of a typing error, correcting the typing error, absent input from a user to produce a corrected character string.

11. The data processing system of claim 10 wherein the typing errors are selected from punctuation errors and spelling errors.

12. The data processing system of claim 10 wherein the typing errors are predefined.

13. The data processing system of claim 10 wherein the instructions further comprise connecting the IP client to an IP server identified by the corrected character string.

14. A computer program product in a computer readable medium for selectively preventing collection of history information on a browser, the computer program product comprising:
first instructions, responsive to receiving a character string at a client, checking the character string for typing errors; and
second instructions, responsive to, upon detection of a typing error, correcting the typing error, absent input from a user to produce a corrected character string.

15. The computer program product of claim 14 wherein the typing errors are selected from punctuation errors and spelling errors.

16. The computer program product of claim 14 wherein the typing errors are predefined.
